(19) United States
(12) Patent Application Publication
(10) Pub. No.: US 2008/0200212 A1
(43) Pub. Date: Aug. 21, 2008

(54) Common graphical user interface for mobile and fixed communication devices

(75) Inventors: Robert J. Morrill, Overland Park, KS (US); Bennett P. Gamel, Overland Park, KS (US)

Correspondence Address: PATTON BOGGS, LLP, 2001 ROSS AVENUE, SUITE 3000, DALLAS, TX, 75201, US

(73) Assignee: EMBARQ HOLDINGS COMPANY, LLC

(21) Appl. No.: 11/708,218

(22) Filed: Feb. 20, 2007

(51) Int. Cl. H04M 1/00

(52) U.S. Cl. 455/566

(57) ABSTRACT

A cordless telephone including a base unit configured to connect to a public switched telephone nework via an end-premise line of a customer of a telecommunications provider. A cordless handset, including an interface to dial a telephone number and a display configured to display a graphical user interface, may communicate with the base unit using voice and data signals. The cordless handset may further be configured to enable a user to select an image on the graphical user interface to communicate an information request signal to a server via the base unit and the public switch telephone network. The cordless handset may receive a response signal including requested information utilized by the cordless handset to generate an image on the display.

### BACKGROUND

Telecommunication services have progressed from telephones being directly connected to a public switched telephone network (PSTN via an end-premise line to cordless handsets that communicate with base units that are connected to the end-premise line for connection to the PSTN. These cordless handsets enable users to have more mobility in a premise, such as a home.

While the cordless telephone provides mobility within a premise, mobile telephones have expanded mobility of users to anywhere that a connection can be made to a mobile telephone network. At first, mobile telephones were developed to handle telephone calls. Over time, as digital communications developed, data communications were made possible. These data communications expanded the capabilities of mobile telephones to include text messaging via short message services (SMS) and Internet access. Further, mobile telephones were developed to include cameras to take photographs and videos and communicate them over the telecommunications network to other subscribers, for example. Music players have also been incorporated into mobile phones to store and play music. Other advanced features, such as video download and display, have also been developed for mobile telephones and mobile telephone communications.

With the advancement of mobile telephone communications, development of non-mobile telephones or fixed telephones, including wired and cordless telephones, has been substantially curtailed due to a lack of consumer demand and an inability to financially justify additional investment in non-growth products, and apathy by fixed telephone manufacturers. Advancement to fixed telephones has primarily been limited to communication standards (e.g., digital communications and frequency bands), in the case of cordless telephones.

### SUMMARY

To improve a user interface with fixed telephones and provide commonality between fixed and mobile telephone services, a fixed telephone with a user-interface consistent with mobile telephones is proposed in accordance with the principles of the present invention. In one embodiment, the user-interface may include a keypad and electronic display for displaying a graphical user interface. A user of the fixed telephone may interact with the user-interface in the same or substantially similar manner as accustomed to when using a mobile telephone. By providing such dramatic improvements to fixed telephones, demand of fixed telephones will increase, thereby making production of the fixed telephones financially justifiable.

One embodiment of a fixed telephone may include a cordless telephone including a base unit configured to connect to a public switched telephone network via an end-premise line of a customer of a telecommunications provider. A cordless handset, including an interface to dial a telephone number and a display configured to display a graphical user interface, may communicate with the base unit using voice and data signals. The data signals may include test, sound, image or any other content that may be communicated in a digital data signal. The cordless handset may further be configured to enable a user to select an image on the graphical user interface to communicate an information request signal to a server via the base unit and the public switch telephone network The cordless handset may receive a response signal including requested information utilized by the cordless handset to generate an image on the display.

One embodiment for communicating over a public switched telephone network may include displaying a graphical user-interface on a cordless handset. The graphical user-interface may be color or otherwise. A first user input may be received by the cordless handset to place a telephone call and communicate voice signals from the cordless handset to the public switched telephone network. A second user input maybe received by the cordless handset, where the second user input includes a selection of a first image display on the graphical user interface. A request signal including data indicative from the cordless handset may be communicated to the public switched telephone network A second image may be displayed on the graphical user interface in response to receiving a response signal including data indicative of a response to the second user input via the public switched telephone network. Another embodiment includes a system for providing data services for fixed telephone telecommunication subscribers. The system may include a server including a processor executing software configured to respond to requests. A media gateway may be in communication with the server and a fixed telephone over a public switched telephone network The software may be configured to receive a first request signal from the fixed telephone and communicate a first response signal in response to the first signal request signal via the media gateway to the fixed telephone.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an exemplary system for providing common services to mobile and fixed communication devices;

FIG. 2 is an illustration of a more detailed system for providing common communication services to mobile and fixed communication devices;

FIG. 3A is an illustration of an exemplary fixed communication device having a user interface consistent with an embodiment of a mobile telephone;

FIG. 3B is an illustration of a handset of the exemplary fixed telephone of FIG. 3A showing an exemplary graphical user interface;

FIG. 3C is an illustration of the handset of the exemplary fixed telephone of FIG. 3A showing another graphical user interface;

FIG. 4 is a block diagram of an exemplary handset showing internal components thereof;

FIG. 5 is a flow diagram of an exemplary process of a fixed telephone performing functions the same or similar to those of a mobile telephone in accordance with the principles of the present invention; and

FIG. 6 is a flow diagram of an exemplary process for a server handling communication services for fixed telephone subscribers.

### DETAILED DESCRIPTION OF THE DRAWINGS

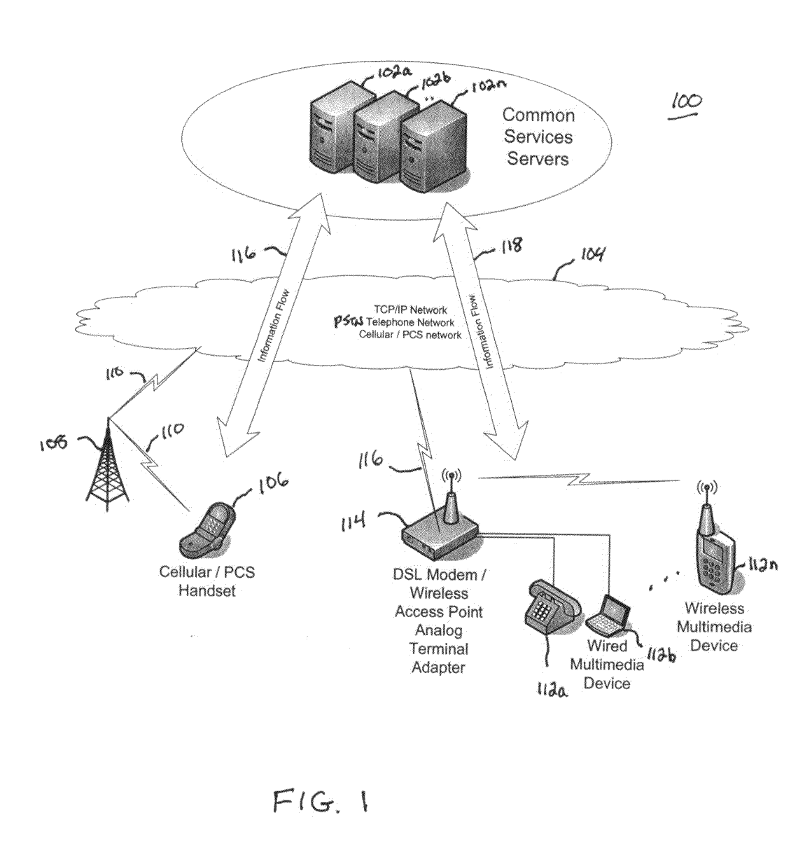

FIG. 1 is an illustration of an exemplary system 100 for providing common services to mobile and fixed communication devices. The system 100 may include one or more common services servers 102a-102n (collectively 102) that are in communication with two or more networks 104. The networks may include a cellular or PCS network public switched telephone network and/or TCP/IP network (e.g., Internet). The common services servers 102 may also be in communication with other networks that communicate with personal communication devices, as understood in the art. The voice and data signals may be digital signals and include text, sound, image, or any other content that may be communicated in a digital data signal

Subscribers using mobile telephones 106 that communicate with a cellular network may communicate via a cell tower 108 using conventional wireless communication signals 110. The communication signals 110 may include voice and data signals using conventional wireless communications protocols, as understood in the art.

Fixed communication devices 112a-112n (collectively 112) may be in communication with the PSTN telephone network 104 via a base unit 114. The base unit 114 may be a digital subscriber line (DSL) modem, wireless access points, analog terminal adapter, or any other component that enables a fixed communication device to communicate with the public switched telephone network. In some embodiments, the fixed communication devices 112 include functionality of the base unit 114. Access to the PSTN may be provided by conventional circuit facilities or new packet based facilities. The fixed communication devices 112 may include a telephone, wired multimedia device, or wireless multimedia device. In accordance with the principles of the present invention, the common services servers 102 may provide the same or similar functionality for the fixed communication devices 112 as the mobile communication devices 106. It should be understood that a fixed communication device 112 maybe any communication device, such as a telephone, that is connected to an end-premise line 116 and has a range that extends within the premise (e.g., house) and, possibly, into surrounding areas (e.g., yard of a house) in the case of the fixed communication device including a wireless handset.

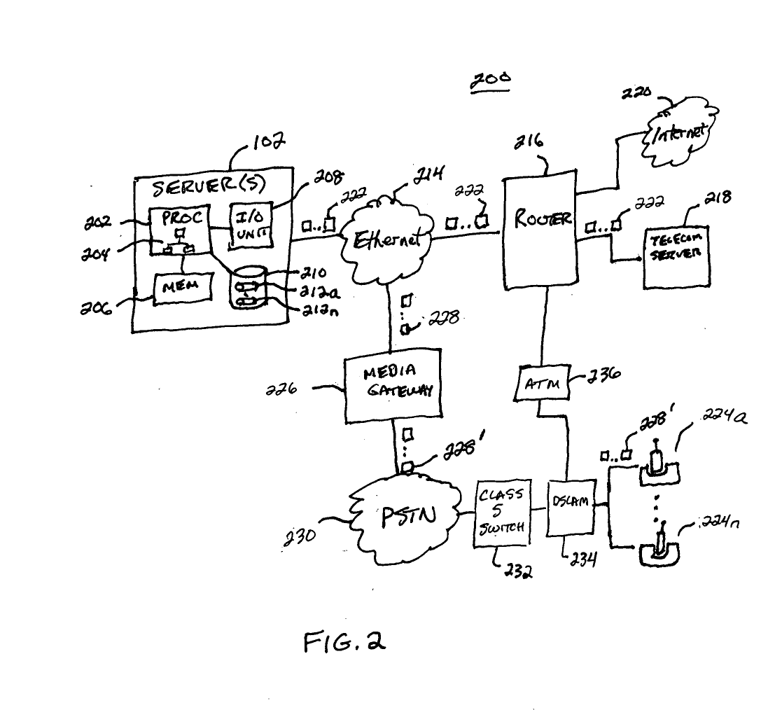

FIG. 2 is an illustration of a more detailed system 200 for providing common communication services to mobile and fixed communication devices. The system 200 may include one or more servers 102 that include a processor 202 that executes software 204. The processor 202 may be in communication with a memory 206, input/output unit 208, and storage unit 210. One or more data repositories 212a-212n (collectively 212) may be stored on the storage unit 210 and be utilized for storing information associated with subscribers of a telecommunications provider. The memory 206 may be utilized to store data and software during execution of the software 204 by the processor 202. The I/O unit 208 may be used for communicating data external from the server 102.

The system 200 may include a packet network 214, such as an Ethernet, router 216, and telecommunications server 218. The router 216 may also be in communication with the Internet 220.

In operation, the common services server(s) 102 may communicate information with the telecom server 218 using data packets 222 via the network 214 and router 216, as understood in the art. In one embodiment, the network 214 is a packet network that communicates digital signals in the form of data packets. The data packets 222 may include information associated with subscribers of the telecommunications provider.

Subscribers using fixed telephones 224a-224n (collectively 224) that have functionality consistent with mobile telephones may be in communication with the common services server(s) 102 to enable a subscriber to use services similar to those of mobile telephones. A media gateway 226 may be in communication with the network 214 to operate as a bridge for converting signals 228 that are commonly used to communicate data over data communications networks to data packets 228′ for communication of the data over the public switched telephone network 230. It should be understood that the principles of the present invention may operate over public and/or private networks. In one embodiment, the communication protocol complies with the SS7 communications standard for communicating voice signals over the PSTN 230. A digital subscriber line access multiplexer DSLAM) 234 is connected between the fixed telephones 224 and class 5 switch 232. The DSLAM 234 is further connected to a packet switch, such as an asynchronous transfer mode switch 236, Ethernet switch, or other switch that is also connected to the router 216. The use of an Ethernet switch may provide for digital subscriber lines (DSL) with Internet protocol virtual private networks (IPVPNs). Data traffic uses the DSL Internet connection via the DSLAM 234, ATM 236, and router 216 rather than passing through the class 5 switch 232.

The common services server(s) 102 may be utilized to service both mobile devices (e.g., cell phones) and fixed devices (e.g., telephones connected to end-premise lines). The software 204 may be configured to provide the same or similar functionality for both types of devices. The software may utilize a single instance on common equipment to handle requests from both mobile and fixed devices. Because the software 204 maybe configured to serve both types of devices, an operator of the common services server(s) 102 may serve many more subscribers (i.e., both mobile and local subscribers), thereby enabling the operator (e.g., telecommunications carrier) to save costs on equipment, communications, service lines, and other service and systems savings.

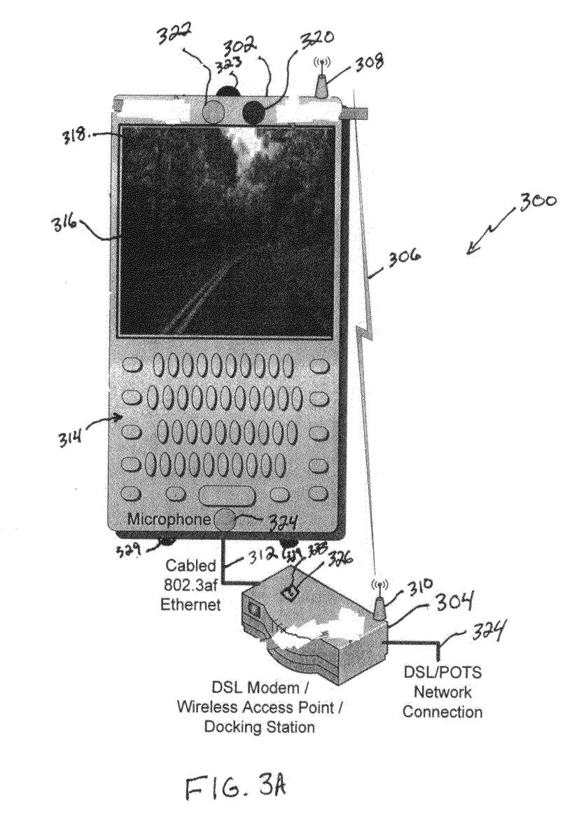

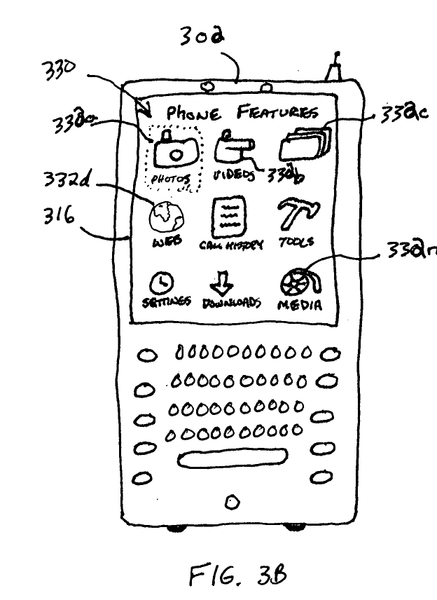

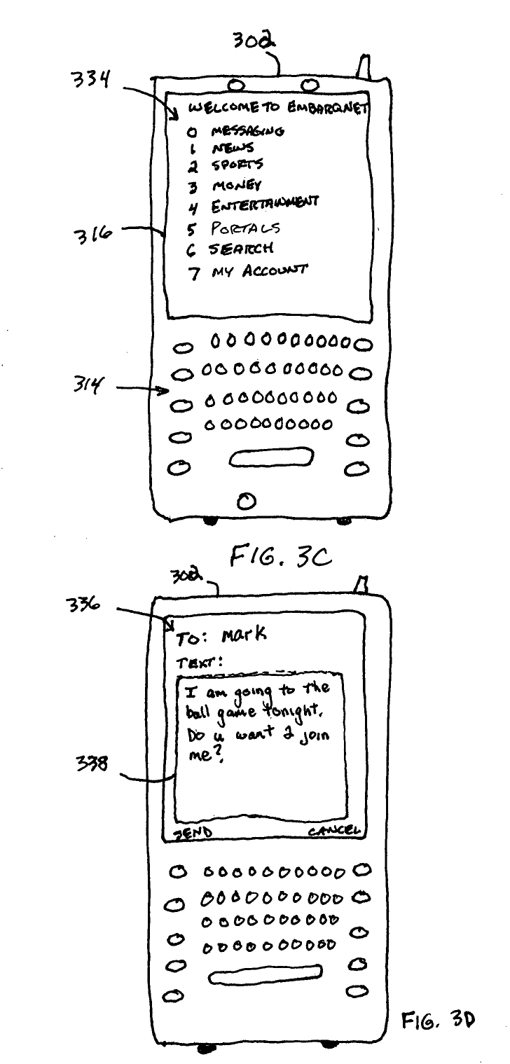

FIG. 3A is an illustration of an exemplary fixed communication device 300 having a user interface consistent (i.e., the same or similar) with an embodiment of a mobile telephone. In this embodiment, a cordless handset 302 that communicates with a base unit 304 via a wireless communication path 306 that utilizes 802.11 “WiFi” wireless protocol or digital enhanced cordless telecommunications (DECI) protocol between antennas 308 and 310 may be utilized by a subscriber. It should be understood that the wireless communication path 306 may support any wireless communications protocol, such as WiFi, DECT, WiMAX, Bluetooth, and/or other technologies and protocols. In one embodiment, the communications path is a broadband communications path, such as a digital subscriber line. Alternatively, a cable 312 may be connected between the cordless handset 302 and base unit 304. The cable 312 may be an 802.3af Ethernet cable. The 802.3af cable provides power over Ethernet, thereby enabling the base unit 304 to receive power from the Ethernet cable and not have to plug into a wall socket.

The cordless handset 302 may include a “qwerty” style keypad 314 and electronic display 316. Alternatively, the cordless handset 302 may utilize a conventional keypad having 10 pushbutton digits and two symbols as understood in the art. It should be understood that any style user interface having keys and functions that may control and interact with a graphical user interface on the electronic display may be utilized in accordance with the principles of the present invention. The electronic display 316 may have any size, shape, and color scheme (e.g., black and white or color). As shown, a photograph 318 is being displayed on the electronic display 316.

Because the cordless handset 302 may provide interactive user interface features, the user interface, including keypad 314 and other user interactive elements (e.g., turn wheel, joystick, etc.) maybe utilized to select graphical elements on a graphical user interface (see FIG. 3B). Additionally, the cordless handset 302 may include a digital camera 320, speaker 322, infrared port 323 and microphone 324. Other functions and features may be included on the cordless handset 302 as understood in the art.

The base unit 304 may be a conventional base unit for wireless handsets, a DSL modem, wireless access point, docking station, or other hardware utilized to communicate signals to and from the cordless handset 302. The base unit 304 may be configured to communicate both voice and data signals with the cordless handset 302. The base unit 304 may be connected to an end-premise line 324. A cradle 326 or other region may include electrical contacts 328 for charging the cordless handset 302 via electrical contacts 329 on the cordless handset 302. Because the cordless handset 302 is typically positioned on a cradle that includes the electrical contacts 328, it is natural that the cordless handset would be powered more regularly than is a mobile phone, which is generally powered at night. As a result of being powered more regularly, hardware and software included in the cordless handset 302 may utilize higher power than a mobile telephone, thereby providing more capabilities than a mobile telephone. For example, the cordless handset 302 may include hardware that is capable of processing video at higher rates. As conventional mobile telephones currently operate at rates of 3.1 megabits per second, the cordless handset 302 (or any other fixed telephone) may utilize protocols that provide enhanced connectivity, such as an asymmetric subscriber line (ADSL) that operates at 8 megabits per second and verrhigh-bit-rate digital subscriber line 2 (VDSL2) that operates up to 25 megabits per second or up to 50 megabits per second in a bonded configuration. In the case of using hardwired fixed telephones, higher communication rates may be achieved and different communications protocols may be utilized. As understood, bit rates and communications protocols may change over time. In addition to having hardware that processes data at higher rates, better electronic displays that consume more power maybe utilized due to the increased access to power.

FIG. 3B is an illustration of the cordless handset 302 of the exemplary fixed telephone 300 of FIG. 3A showing an exemplary graphical user interface 330. The electronic display 316 shows the graphical user interface 330 having selectable images or icons 332a-332n (collectively 332) that enables a user to select a function or link. A user may use buttons, roller wheel, touch screen, or other component on the cordless handset 302 to select one of the images to cause the cordless handset 302 to execute the associated function or request the associated link For example, if a user selects the highlighted “photos” image 332a, another graphical user interface may be displayed on the electronic display 316 that shows thumbnails (i.e., small, low resolution images) or other identifiers of photographs that have been saved on the cordless handset 302. Other functions that may be included on the fixed telephone 300 may include loading and playing of music files, games, ringers, ring tones, and any other functions that may be performed on mobile telephones. Additionally, conventional network services, such as voicemail, network address book, web portal, etc., may be provided to the fixed telephone 300.

FIG. 3C is an illustration of the cordless handset 302 of the exemplary fixed telephone 300 of FIG. 3A showing another exemplary graphical user interface 334. The electronic display 316 shows the graphical user interface 334 resulting from a user selecting a web image 332d (FIG. 3B) on the cordless handset 302. The graphical user interface 334 includes a list of selectable images, in this case text links, that the user may select by pressing a digit on the keypad 314 or by other component on the cordless handset 302. In response to the user selecting one of the images, the cordless handset 302 communicates a request for the associated link to be downloaded or displayed, if already stored in cache memory on the cordless handset 302.

FIG. 3D is an illustration of the cordless handset 302 of FIG. 3A displaying another exemplary graphical user interface 336. The graphical user interface is illustrative of a text message function. A text message to be sent to “Mark” is being prepared in a text box 338. The user may elect to send the text message when complete or cancel the text message. Other text messaging functions as understood in the art, may be utilized on the cordless handset 300 in accordance with the principles of the present invention. If a short messaging services (SMS) signaling protocol is available for use by the cordless handset 302, then such a communication technique may be utilized for communicating text messages for subscribers. SMS messages are routed over the broadband connection via an Internet Protocol (IP) to a common services server of the service provider, as providing an SMS application on the server is similar to providing other applications. Alternatively, another signaling protocol may be utilized.

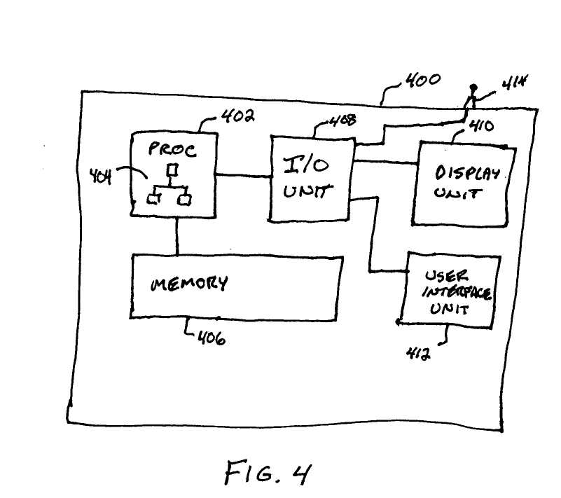

FIG. 4 is a block diagram of an exemplary cordless handset 400 showing internal components thereof. The cordless handset 400 may include a processor 402 that executes software 404 that enables a user of the cordless handset 400 to utilize the handset for telephone calls and/or operate a graphical user interface. The processor 402 may be in communication with a memory 406 that stores settings information, graphical user interface information, and other user defined information (e.g., speed dial phone numbers, contact information, calendar information, gaming information, and any other information that the software 404 may enable a user to store and use). The processor 402 may further be in communication with an input/output (I/O) unit 408 that is utilized to communicate signals with an electronic display unit 410, user interface unit 412 (e.g., keypad, roller wheel, and/or other components), and one or more antenna 414. The software 404 may be configured to communicate information (i.e., voice and data) using a wireless handset communication protocol to a base unit as understood in the art.

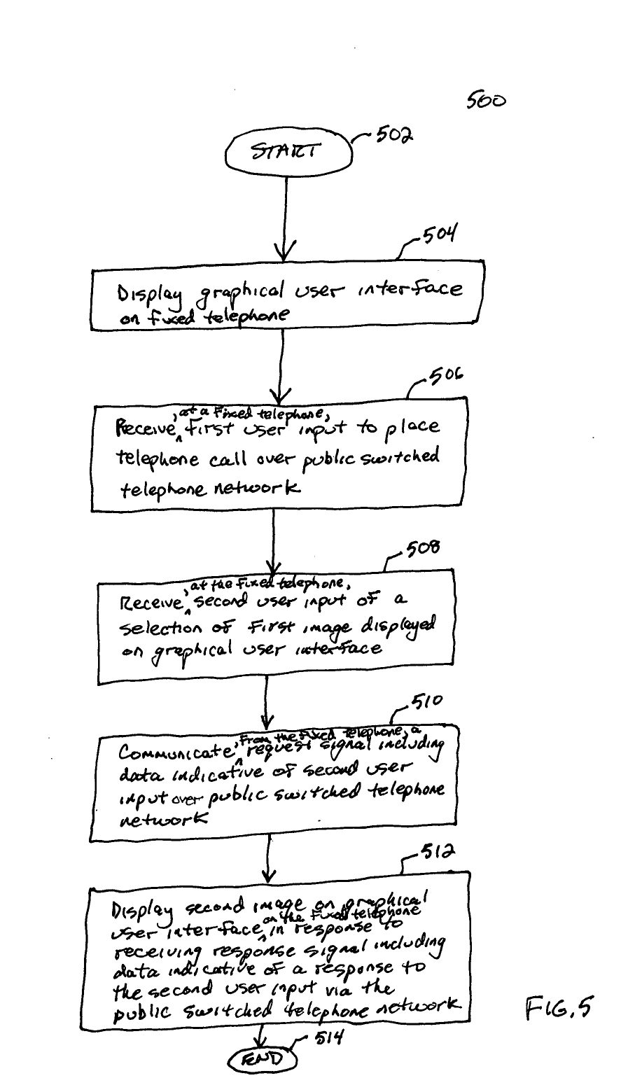

FIG. 5 is a flow diagram of an exemplary process 500 of a fixed telephone performing functions the same or similar to those of a mobile telephone in accordance with the principles of the present invention. The process 500 starts at step 502. At step 504, a graphical user interface is displayed on the fixed telephone. At step 506, a first user input to place a telephone call over a public switched telephone network is received at the fixed telephone. The first user input may be an entry of a telephone number on the fixed telephone or selection of an image (e.g., phone number displayed as text on a graphical user interface or selection of a contact on the fixed telephone). At step 508, a second user input of a selection of a first image displayed on a graphical user interface may be received at the fixed telephone. The second user input may include selection of an icon of a website on the graphical user interface using a user selection element, such as a key. At step 510, a request signal including data indicative of the second user input may be communicated from the fixed telephone over the public switched telephone network In response to receiving a response signal including data indicative of a response to the second user input via the public switched telephone network, a second image may be displayed on the graphical user interface on the fixed telephone at step 512. For example, the response signal may include information, such as graphics and text, of a webpage, such as a news webpage (e.g., cnn.com). The process ends at step 514.

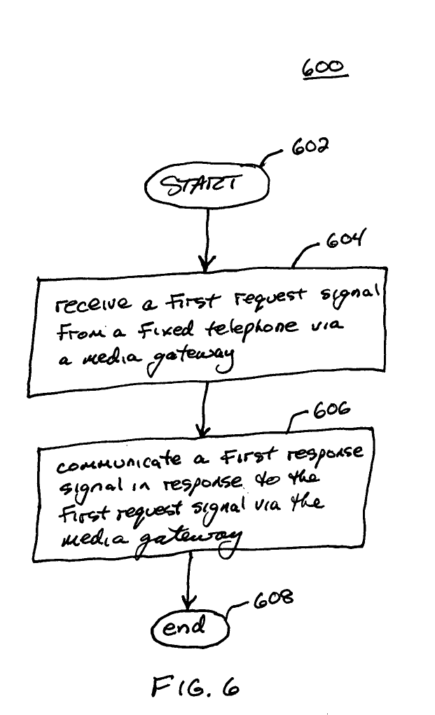

FIG. 6 is a flow diagram of an exemplary process 600 for a server handling communication services for fixed telephone subscribers and, in particular, a multi-media call. The process 600 starts at step 602. At step 604, a first request signal is received from a fixed telephone via a media gateway. The first request signal may be a request for access data from a webpage on the Internet. The call maybe established using packet telephony constructs (e.g., using E.164 telephone numbers), such as session initiated protocol or other communications protocol. Once the call is established, the data channel may provide additional information that can be intermixed via the multi-media display. Call control is done via the voice control elements. Intelligence in the fixed telephone may also help to control the display. For example, a call may be received at the fixed telephone from a brokerage house. The broker may notify a customer using the fixed telephone to sell a particular stock The customer may place the call on speaker phone and pull up his web based portfolio on the fixed. telephone to understand the impact of the sale while continuing to speak with the broker.

Continuing with the process 600, a first response signal may be communicated in response to the first request signal via the media gateway at step 606. The process ends at step 608. In addition, the process 600 may include receiving a second request from a mobile telephone. The server may be configured to handle requests from both fixed and mobile telephone subscribers.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A cordless telephone, comprising:
a base unit configured to connect to a public switched telephone network via an end-premise line of a customer of a telecommunications provider, and
a cordless handset including an interface to dial a telephone number and an electronic display configured to display a graphical user interface, said base unit configured to communicate voice and data signals with said cordless handset, said cordless handset further configured to enable a user to select an image on the graphical user interface to communicate an information request signal to a server via said base unit and the public switched telephone network and receive a response signal including requested information utilized by said cordless handset to generate an image on the electronic display.

2. The cordless telephone according to claim 1, wherein the information request signal is a request to receive information from the Internet.

3. The cordless telephone according to claim 1, wherein said cordless handset is further configured to generate and receive text messages.

4. The cordless telephone according to claim 1, wherein said cordless handset further includes a camera for taking photographs.

5. The cordless telephone according to claim 1, wherein the interface is a keypad

6. The cordless telephone according to claim 1, wherein said base unit is configured to communicate with the public switched telephone network using a digital subscriber line signal.

7. The cordless telephone according to claim 1, wherein said base unit is configured to charge a battery in said cordless handset.

8. The cordless telephone according to claim 1, wherein the image is a webpage.

9. The cordless telephone according to claim 1, wherein the image includes a photograph.

10. A method for communicating over a public switched telephone network, said method comprising:
displaying a graphical user interface on a fixed telephone;
receiving a first user input by the fixed telephone to place a telephone call and communicating voice signals from the fixed telephone to the public switched telephone network;
receiving a second user input by the fixed telephone of a selection of a first image displayed on the graphical user interface;
communicating a request signal including data indicative of the second user input from the fixed telephone to the public switched telephone network; and
displaying a second image on the graphical user interface in response to receiving a response signal including data indicative of a response to the second user input via the public switched telephone network.

11. The method according to claim 10, wherein communicating a request signal includes data representative of a website located on the Internet.

12. The method according to claim 10, further comprising communicating a text message destined for another telephone in response to receiving a text message input from a user of the mobile telephone.

13. The method according to claim 10, further comprising:
capturing an image by the fixed telephone; and
storing the image on the cordless handset.

14. The method according to claim 10, further comprising generating dual tone multiple frequencies in response to receiving the first user input.

15. The method according to claim 10, further comprising communicating a radio frequency signal to a base unit.

16. The method according to claim 10, further comprising charging a battery.

17. The method according to claim 10, wherein displaying a second image includes displaying a webpage.

18. The method according to claim 10, wherein the displaying a second image includes displaying a photograph.

19. The method according to claim 10, wherein receiving the first and second user inputs includes a receiving the inputs on a cordless handset of the fixed telephone.

20. A system for providing data services for fixed telephone telecommunications subscribers, said system comprising:
a server including a processor executing software configured to respond to requests; and
a media gateway in communication with said server and a fixed telephone over a public switched telephone network, the software configured to receive a first request signal from the fixed telephone and communicate a first response signal in response to the first request signal via said media gateway to the fixed telephone.

21. The system according to claim 20, wherein the software is further configured to receive a second request signal from a mobile telephone and communicate a second response signal in response to the second request signal.

22. The system according to claim 20, wherein the first request signal includes a request to access information on a website.

23. A method for providing data services for fixed telephone telecommunications subscribers, said method comprising:
receiving a first request signal from a fixed telephone via a media gateway; and
communicating a first response to the first request signal via the media gateway to the fixed telephone.

24. The method according to claim 23, further comprising:
receiving a second request signal from a mobile telephone; and
communicating a second response to the second request signal.

25. The method according to claim 23, wherein receiving the first request signal includes receiving a request for information from a website.
